(19) United States
(12) Patent Application Publication
(10) Pub. No.: US 2008/0218451 A1
(43) Pub. Date: Sep. 11, 2008

(54) Organic electroluminescence display

(75) Inventors: Mitsuhide Miyamoto, Kokubunji (JP); Tohru Kohno, Kokubunji (JP); Masato Ishii, Tokyo (JP); Naruhiko Kasai, Yokohama (JP); Hajime Akimoto, Kokubunji (JP)

Correspondence Address: Stanley P. Fisher;Reed Smith LLP, Suite 1400, 3110 Fairview Park Drive, Falls Church, VA, 22042-4503, US

(73) Assignee: Hitachi Displays, Ltd.

(21) Appl. No.: 12/000,293

(22) Filed: Dec. 11, 2007

(30) Foreign Application Priority Data
Mar. 7, 2007 (JP) 2007-057103

(51) Int. Cl. G09G 3/30

(52) U.S. Cl. 345/76

(57) ABSTRACT

The voltage-current property of the specific pixel is measured to store the data on a single line in a line memory. The property data of adjacent pixels are compared. A failure determination unit detects whether or not the pixel to be compared is faulty. If it is determined as being faulty, the faulty pixel is removed from the pixel group to be compared. The burn-in determination unit performs the comparison using normal pixels only to provide the correct burn-in data. The calculation unit reflects the burn-in data in the image data from the host.

### CLAIM OF PRIORITY

The present application claims priority from Japanese application JP 2007-057103 filed on Mar. 7, 2007, the content of which is hereby incorporated by reference into this application.

### FIELD OF THE INVENTION

The present invention relates to an organic electroluminescence display, and more particularly to a display technique for correcting the change in the emission property of the organic electroluminescence device over operation time.

### BACKGROUND OF THE INVENTION

Instead of the CRT which has been generally employed as the display, the demand for the use of the liquid crystal display, the plasma display and the like which has been put into practical use as the flat display has been increased. Furthermore, the display using the organic electroluminescence display (hereinafter referred to as OLED), and the display having electron sources using the field emission arranged in matrix for forming the image by allowing the fluorescent substance to emit on the anode has been in the development so as to be put into practical application.

The organic electroluminescence display has the following advantageous points:

(1) Unlike the liquid crystal display, self light-emitting type, requiring no backlight.
(2) Low voltage required for emission, that is, 10 V or lower, thus reducing power consumption.
(3) Unlike the plasma display or FED display, no vacuum structure is required, thus reducing the weight and thickness of the product.
(4) Short response time taking only several micro seconds while providing excellent video features.
(5) Wide view angle of 170° or higher.

Despite the aforementioned characteristics, the organic electroluminescence has disadvantages. One of those disadvantages is that the organic electroluminescence emission device (hereinafter referred to as an OLED device) will change its emission property over operation time. In the case where the specific image is displayed for an elongated period of time, the property change in the OLED may deteriorate the property of the specific portion of the displayed image, which appears as the “burn-in” on the display. The burn-in is distinguishable compared to the case of gradual decrease in the luminance of the screen of the display. In order to make the burn-in less noticeable, properties of the OLED devices of all the images have to be detected, and the detection results are required to be feedbacked to the input signal from the host.

The property change in the OLED device may appear as the change in the voltage-current property of the OLED device, and as the change in the current-emission luminance property. Above all, the change in the voltage-current property decreases the flow rate of the current over the operation time even if the same voltage is applied. The aforementioned phenomenon is shown in FIG. 16 where the x-axis denotes the voltage applied to the OLED device, and the y-axis denotes the density of the current applied to the OLED device. The type 1 denotes the initial property of the OLED device, and the type 2 denotes the property of the OLED device after the elapse of the time. Assuming that the emission of the OLED device is proportional to the current flowing to the OLED device, the emission luminance of the OLED device changes over time although the same voltage is applied. As a result, accurate image cannot be displayed.

In other words, the higher voltage has to be applied for application of the same current for the purpose of performing the similar emission. FIG. 17 shows the change in the voltage applied for the application of the same current to the OLED device where the x-axis denotes the operation time, and the y-axis denotes the voltage applied for the constant application of current to the OLED device. FIG. 17 indicates that the application voltage has to be increased as well as the operation time for the application of the same current to the OLED device.

In order to display the normal images on the organic electroluminescence display, periodic measurement of the voltage-current property of the OLED devices of all the pixels, and feedback of the measurement results to the image signals to be input are required. The aforementioned technique is disclosed in such patent documents as JP-A No. 2005-156697 and JP-A No. 2002-341825.

### SUMMARY OF THE INVENTION

The aforementioned patent documents disclose how emission of the OLED device for writing of the image data for displaying the image or image-forming, and detection of the OLED device properties are balanced. However, the aforementioned documents disclose no basis, based on which the OLED device property change is measured. If the basis on which the OLED device property change is determined is not appropriate, the incorrect data may be feedbacked. This may fail to display the correct image, thus making the feedback meaningless.

One of methods which have been performed is that each pixel property is stored, and comparison is made between the newly measured data and the previously measured data such that the resultant difference is feedbacked as data of the change overtime or the burn-in. In the case where the pixel is turned to be the abnormal pixel such as disconnection or short circuit during the lifetime, the incorrect data may be feedbacked.

In another method conventionally performed, the comparison is made between the OLED device property of the reference pixel and each OLED device property of the respective pixels. The reference pixel may change over time, and in such a case, the basis may be changed, thus failing to perform the appropriate feedback. If the reference pixel is far away from the image display area, the OLED device property may be influenced by the temperature difference between the image display area and the reference pixel. The appropriate feedback to the image data cannot be performed unless the difference is appropriately corrected.

It is an object of the present invention to eliminate the influence of the temperature difference between the points inside and outside the display area resulting from the comparison between OLED devices of adjacent pixels in the display area with respect to the deterioration of the OLED device over time rather than the comparison with the OLED device of the reference pixel outside the display area.

However, the abnormal pixel exists even in the display area. The comparison with the abnormal pixel may result in the incorrect comparison data, failing to perform the correct feedback to the image data. In the present invention, when the adjacent OLED devices are compared, the determination is made whether or not the pixel to be compared is abnormal. If it is determined to be abnormal, it is not subjected to the comparison. As the subject pixel is always compared with the normal pixel, the correct feedback data may be obtained.

The OLED device is compared with the predetermined pixel as the reference rather than comparing the adjacent pixels with respect to the property of the OLED device on the assumption that the reference pixel may change into the abnormal one during the lifetime. In the present invention, the countermeasure to cope with such change is provided. That is, the present invention has the detection unit for detecting the data indicating the transition of the reference pixel into the abnormal pixel such that the transformed reference pixel is removed to be replaced with the other pixel. The specific countermeasures will be described below.

(1) A display unit includes a screen on which plural pixels each having an OLED device are arranged in a matrix, which measures a property of the OLED device at a predetermined time interval to reflect a change in the property of the OLED device in an image signal. The change in the property of the OLED device of a subject one of the plural pixels is obtained by comparing between the property of the OLED device of the subject pixel and the property of the OLED device of another pixel, which exist on a same scanning line.
(2) In the aforementioned structure, another pixel is adjacent to the subject pixel.
(3) In the aforementioned structure, plural pixels are set as another pixel to obtain the change in the property of the OLED device of the subject pixel by comparing a property derived from a statistical processing of the property of the OLED device of the plural pixels and the property of the OLED device of the subject pixel.
(4) The aforementioned structure includes a line memory for storing the property of the OLED device of the pixel on the scanning line.
(5) A display unit includes a screen on which plural pixels each having an OLED device are arranged in a matrix, which measures a property of the OLED device at a predetermined time interval to reflect a change in the property of the OLED device in an image signal. The change in the property of the OLED device of a subject pixel is obtained by comparing the property of the OLED device of the subject pixel and that of another pixel in an image display area. The property of the OLED device of another pixel is in a predetermined range of the property of the OLED device.
(6) In the aforementioned structure, another pixel and the subject pixel exist on a same scanning line.
(7) In the aforementioned structure, the property of the OLED device of the subject pixel is represented by a voltage between terminals of the OLED device. The property of the OLED device of the another pixel is represented by a voltage between terminals of the OLED device. The property of the OLED device of the another pixel is represented by the voltage between terminals of the OLED device for receiving a specific current application within a predetermined range.
(8) In the aforementioned structure, another pixel exists adjacent to the subject pixel, both of which exist on the same scanning line.
(9) In the aforementioned structure, when the property of the OLED device of the another pixel is not in the predetermined range of the property of the OLED device, the property of the OLED device of the subject pixel is compared with that of a pixel adjacent to the another pixel.
(10) The aforementioned structure has a line memory for storing the property of the OLED device of the pixel on the scanning line.
(11) A display unit includes a screen on which plural pixels each having an OLED device are arranged in a matrix, which measures a property of the OLED device at a predetermined time interval to reflect a change in the property of the OLED device in an image signal. The change in the property of the OLED device of a subject pixel is obtained by a comparison with the property of the OLED device of a predetermined reference pixel. The property of the OLED device of the predetermined reference pixel is in a predetermined range. The property of the OLED device of the reference pixel is subjected to a periodic inspection whether or not the property of the OLED device of the reference pixel is in the predetermined range.
(12) In the aforementioned structure, a plurality of the reference pixels exist, and when the property of the OLED device of the plurality of the reference pixels is not in the predetermined range of the property of the OLED device, another one of the reference pixels is subjected to the comparison with respect to the property of the OLED device.
(13) In the aforementioned structure, the property of the OLED device of the subject reference pixel is represented by a voltage between terminals of the OLED device. The property of the OLED device of the reference pixel is represented by a voltage between terminals of the OLED device. The property of the OLED device of the reference pixel is represented by the voltage between terminals of the OLED device for receiving a specific current application within a predetermined range.
(14) In the aforementioned structure, the change in the property of the OLED device of the subject pixel is detected by the comparison with the property of the OLED device of the reference pixel at each measurement of the property of the OLED device of the subject pixel.

The aforementioned features allow the correct evaluation with respect to the deteriorated property of the OLED device in the display area, thus providing the appropriate feedback data of the image data from the host. The present invention allows accurate images to be formed. The effects resulting from the features will be described below.

In an aspect of the present invention, the property of the OLED device of the specific pixel is compared with that of the OLED device of the other pixel on the same scanning line. The OLED devices in substantially the same area may be compared, which are not susceptible to such factor as the temperature. This makes it possible to perform the feedback with respect to the OLED device property change further accurately.

In the aspect of the present invention, as the OLED device of the specific pixel is compared with that of the adjacent pixel on the same scanning line, the condition difference owing to the location becomes negligible, and comparison may be performed in more detail.

In the aspect of the present invention, as the pixel to be compared reflects the property of the plural pixels on the same scanning line, such pixel may contribute to the stable comparison, thus reducing the feedback error.

In the aspect of the present invention, the display unit includes the line memory for storing the property of the OLED device of the pixel on the single line. This makes it possible to easily perform the comparison with the specific pixel.

In another aspect of the present invention, the property of the OLED device of the specific pixel is compared with the OLED device of the pixel in the display area only when its property is within a predetermined range. This makes it possible to avoid the determination error.

In the aspect of the present invention, the other pixels to be compared are on the same scanning line so as to easily perform the comparison.

In the aspect of the present invention, the voltage between terminals of the OLED device through application of the specific current is measured as the property of the OLED device. This makes it possible to easily perform the comparison, and to eliminate the faulty pixel from those subjected to the burn-in determination.

In the aspect of the present invention, as the pixel to be compared is adjacent to the specific pixel on the same scanning line, the comparison may be easily performed. The accuracy in relation to the location may also be improved.

In the aspect of the present invention, if the OLED device of the pixel adjacent to the specific pixel having the OLED device for comparison therebetween is faulty, the OLED device of the pixel next to the faulty pixel is subjected to the comparison. This may allow the comparison to be performed so as to generate the feedback data.

In the aspect of the present invention, the display unit includes the line memory for coping with various measurement methods of the OLED device property and comparison methods.

In another aspect of the present invention, the property of the OLED device of the specific pixel is compared with that of the reference pixel. The periodic inspection is conducted whether or not the property of the OLED device of the reference pixel is in the predetermined range. This may avoid the determination error irrespective of the transition of the reference pixel to the faulty one.

In the aspect of the present invention, plural pixels are set as the reference pixels. If one of those reference pixels is changed to the faulty one, another reference pixel may be used for the comparison. This may avoid interruption of the feedback to the image data owing to loss of the reference pixel to be compared.

In the aspect of the present invention, as the voltage between terminals of the OLED device through application of the specific current is set as the property of the OLED device, the property measurement and the comparison may be easily performed.

In the aspect of the present invention, at each detection of the property of the OLED device of the specific pixel, the determination is made with respect to the abnormality of the pixel as well as performing the burn-in detection. This makes it possible to eliminate the line memory.

### BRIEF DESCRIPTION OF THE DRAWINGS

FIG. 1 is a view showing an example of an organic electroluminescence display unit;

FIG. 2 A is a view showing the OLED device in a short circuit state;

FIG. 2B is a view showing the OLED device in a disconnection state;

FIG. 3 is a view showing a voltage-current property of the OLED device;

FIG. 4 is a view schematically showing the structure of the organic electroluminescence display;

FIG. 5 is a view showing an example of a drive circuit of the pixel;

FIG. 6 is a view showing an example of a property detection circuit of the OLED device;

FIG. 7 is a view showing an example with respect to detection of the OLED device property;

FIG. 8 is a view showing another example of the property detection circuit of the OLED device;

FIG. 9 is a view showing another example with respect to detection of the OLED device property;

FIG. 10 is a view showing an example of an organic electroluminescence display according to a first embodiment;

FIG. 11 is a view showing an example of the property detection;

FIG. 12 is a view showing an example of the property detection data;

FIG. 13 is a view showing an example of an organic electroluminescence display unit according to a third embodiment;

FIG. 14 is a view showing an example of an organic electroluminescence display unit according to a fourth embodiment;

FIG. 15 is a view showing a drive circuit of a pixel in the fourth embodiment;

FIG. 16 is a view showing a voltage-current property of the OLED device; and

FIG. 17 is a view showing an example of the change in the OLED device property over time.

### DETAILED DESCRIPTION OF THE PREFERRED EMBODIMENTS

Embodiments of the present invention will be described in detail.

### First Embodiment

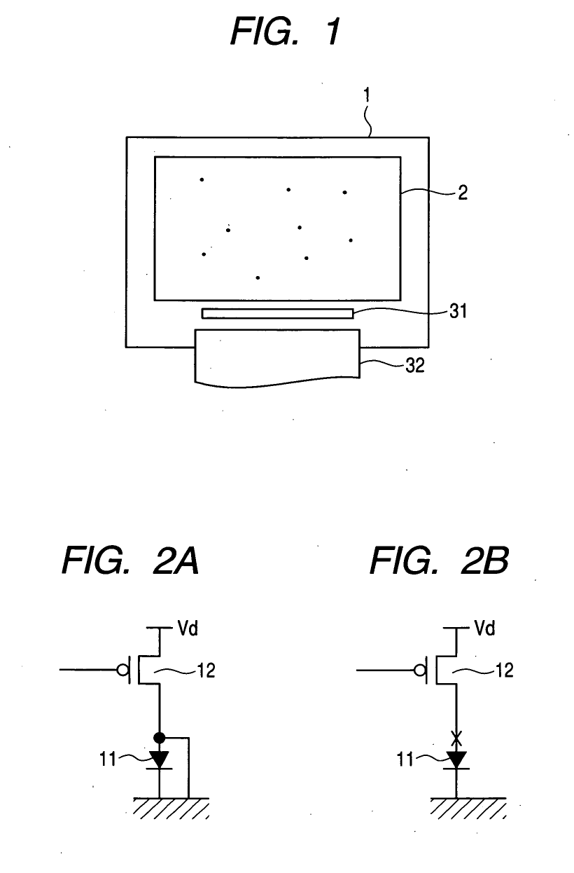

FIG. 1 shows an example of an organic electroluminescence display unit according to the present invention. Referring to FIG. 1, a display area 2 is formed to occupy a major area of an organic electroluminescence display panel 1. A drive IC 31 for driving the organic electroluminescence display panel 1 is disposed below the screen. A flexible wiring substrate 32 is attached to the organic electroluminescence panel 1 further below the drive IC 31. External image signals, power supply and the like will be fed to the organic electroluminescence display panel 1 through the flexible wiring substrate 32. Generally, the flexible wiring substrate is folded to the rear of the organic electroluminescence display panel so as to be stored in the frame.

A large number of pixels PX are formed on the display area 2 shown in FIG. 1. All the pixels PX are not normal, and abnormal pixels exist as indicated by black points shown in FIG. 1. The aforementioned point denotes the portion where the OLED device dose not emit light, or the luminescence is considerably low resulting from the short circuit or release of the OLED device of the pixel. Satisfying the strict requirement to make all the pixels PX normal is totally unrealistic because it may increase the production costs enormously. Accordingly, the certain number of abnormal pixels may be allowed so long as the viewers are not bothered. The number of the abnormal pixels may be increased during the operation.

The abnormal pixels are caused by short circuit or disconnection of an OLED device 11. FIG. 2A shows an example where the short circuit occurs in the OLED device 11. Referring to FIG. 2A, an OLED drive TFT 12 and the OLED device 11 are connected in series between a power supply Vd and the reference potential. The reference potential denotes the potential set as the reference of the organic electroluminescence display unit, the concept of which is broad enough to contain grounding. The OLED device 11 is formed by laminating plural (5 layers in general) organic electroluminescence layers, having the thickness of about 20 nm. Each layer is so thin that the device is likely to cause the short circuit in the presence of the foreign substance.

FIG. 2B shows an example where the disconnection occurs in the OLED device 11. The electric current may not be applied to the OLED device 11 over a prolonged period of operation even if the disconnection does not occur.

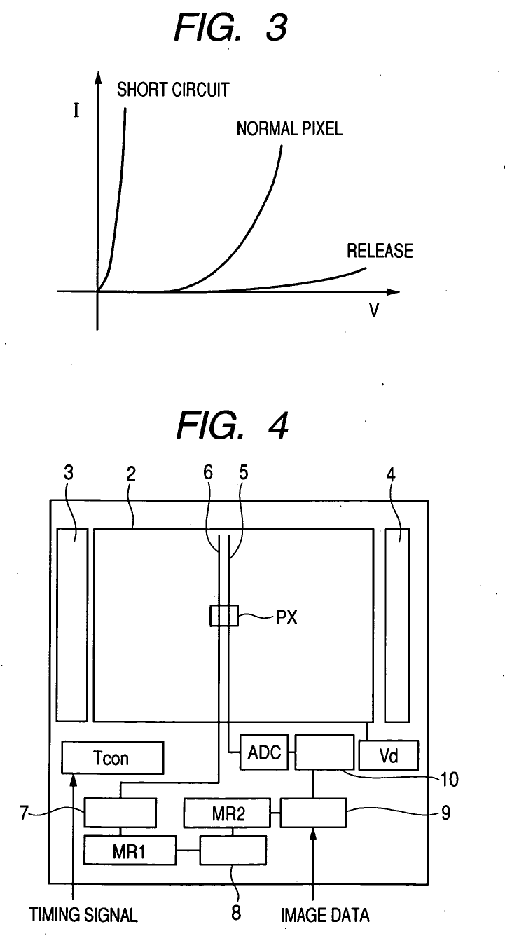

FIG. 3 shows the voltage-current property of the OLED device 11. As the OLED device 11 is formed as a diode, the current sharply rises when the voltage reaches a certain level. FIG. 3 shows each property of the OLED device 11 obtained when the short circuit occurs, the disconnection occurs, and it is normally operated. As the voltage-current property is detected as the property of the OLED device 11, the range of the normal pixel may be set in accordance with the voltage-current property as shown in FIG. 3.

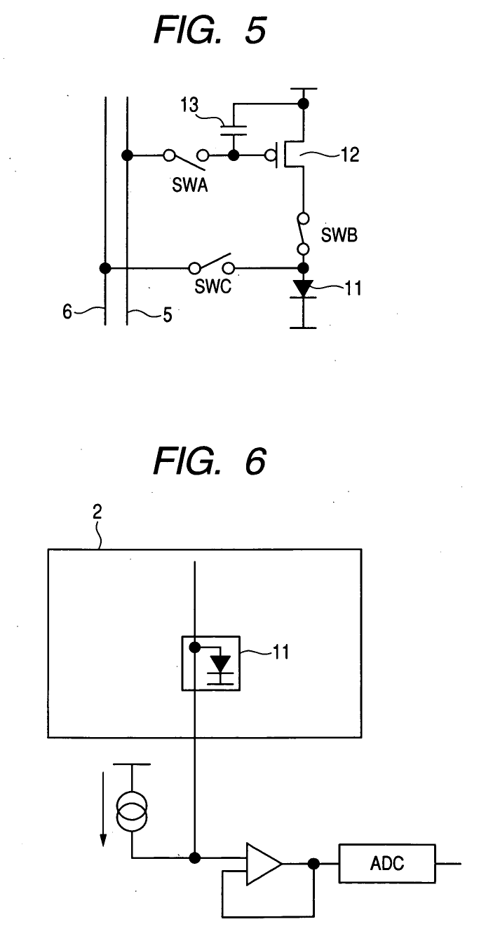

FIG. 4 shows an example of the organic electroluminescence display according to the present invention. FIG. 5 shows an exemplary structure of the pixel PX shown in FIG. 4. A large number of pixels PX are arranged in matrix on the display area 2. Each pixel includes an anode, a cathode, the OLED device 11 which exhibits the organic electroluminescence layer therebetween, a thin film transistor (TFT) for driving the OLED device, a storage capacitor and the like. A display scanning circuit 3 for forming the image by scanning the screen by the line is disposed to the left of the display area 2. That is, the image data are supplied to the selected line from the signal drive circuit.

A detection scanning circuit 4 for detecting the property of the OLED device 11 is disposed to the right of the screen. Each voltage-current property of the respective OLED devices 11 is measured for detecting the property of the OLED device 11 at every line. The scanning for the measurement may be performed separately from the scanning for forming the image.

Each pixel is connected to a data line 5 for supplying the image signal, and a detection line 6 for measuring the property of the OLED device 11, that is, voltage-current property. FIG. 5 shows the drive circuit of the pixel part. Referring to FIG. 5, the OLED drive TFT 12, a B switch SWB, and the OLED drive TFT 12 are connected in series between the power supply Vd and the reference potential. The B switch SWB serves to control to apply/not to apply the current to the OLED device 11 for emission, and generally is formed as a TFT switch. The display scanning circuit 3 transmits the control signal to the B switch SWB.

Referring to FIG. 5, the OLED drive TFT 12 serves as the TFT to control the flow of the current applied to the OLED device 11 for determining the tone of the image. When an A switch SWA shown in FIG. 5 is closed, the image signal from the signal drive circuit is loaded into the storage capacitor 13. The charge stored in the storage capacitor 13 fixes the gate voltage of the OLED drive TFT 12 to determine the flow of the current applied to the OLED device 11. When the B switch SWB is closed at this time, the current is applied to the OLED device 11 for emission such that the image is formed. When the image signal is loaded into the storage capacitor 13, the A switch SWA is opened, and the signal voltage is maintained in the storage capacitor 13 for a period corresponding to a single frame until the scanning line is selected again.

Referring to FIG. 5, a C switch SWC is disposed between the anode of the OLED device 11 and the detection line 6. Generally, the C switch SWC is formed as the TFT, and is opened while the image forming current is applied to the OLED device 11. Upon detection of the OLED device property, the B switch SWB is opened, and the C switch SWC is closed so as to detect the voltage-current property of the OLED device 11.

The property of the OLED device 11 is detected by a detection unit 7 through the process as shown in FIG. 6 or 8. FIG. 6 shows the case where the detection unit 7 has a constant current source. That is, the constant current source disposed in the detection unit 7 supplies the constant current to the pixel to be measured through the detection line 6. When the OLED device 11 is deteriorated, the resistance of the OLED device 11 becomes high enough to raise the voltage between terminals, that is, the plate voltage of the OLED device 11. The thus increased plate voltage of the OLED device 11 is detected by a differential amplifier. The detected plate voltage is converted into the digital data by an analog-digital converter ADC so as to be stored in a first memory MR1 shown in FIG. 4. The first memory MR1 stores detection results of the pixels PX on the single line.

FIG. 8 shows the case where the detection unit 7 has a constant voltage source Vdd. Likewise the case of the constant current source as described above, the resistance of the OLED device 11 increases as it is deteriorated, thus raising the plate voltage thereof. The thus increased plate voltage is detected by the differential amplifier. The detected plate voltage is converted into the digital data by the analog-digital converter ADC so as to be stored in the first memory MR1. The first memory MR1 stores the detection results of the pixels PX on the single line likewise the case using the constant current source.

Referring to FIG. 4, the detection is performed by each line such that all the data of the OLED device 11 on the line are stored in the first memory MR1. A determination unit 8 determines with respect to each deterioration state of the respective OLED devices in reference to the property of the OLED devices 11 stored in the first memory MR1. The difference of the property deterioration between the pixels is determined by comparing the adjacent pixels on the single line subjected to the property detection.

The result of the determination made by the determination unit 8 with respect to the required correction amount will be stored in a second memory MR2. A calculation unit 9 shown in FIG. 4 receives the input of the data on the single line. In the calculation unit 9, the correction amount is added to the data from the host in reference to the second memory MR2 so as not to reflect the influence of the burn-in to the display image. The image data corrected by the single line is retained in a latch 10 so as to be transferred by the single line.

The image data output from the latch 10 are digital having the luminance tone displayed in digital. The analog-digital converter ADC serves to convert the digital data into the voltage applied to the OLED device 11. The voltage is transferred to be applied to the respective pixels from the ADC via the data line 5. The aforementioned operation is controlled by a timing controller Tcon. The plate voltage is supplied to the OLED devices 11 for all the pixels shown in FIG. 1 from the voltage source Vd.

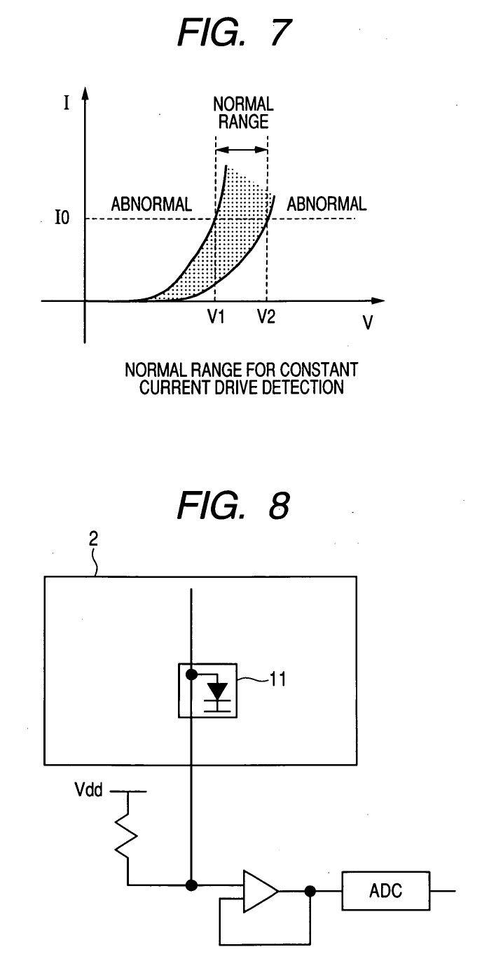

FIG. 6 shows the circuit for detecting the property of the OLED device 11. The operation of the circuit has been already described. FIG. 7 shows an example of the detection results of the OLED device 11 using the circuit shown in FIG. 6. Referring to FIG. 7, the x-axis denotes the plate voltage generated in the anode of the OLED device 11, and y-axis denotes the voltage applied to the OLED device 11. FIG. 6 shows the case where the constant current source is applied to the OLEd device 11. Accordingly, the y-axis takes a constant value, for example I0 during the inspection.

The abnormality which occurs in the OLED device 11 may appear as the abnormality in the plate voltage of the OLED device 11. It is possible to distinguish the normal pixel from the abnormal one in reference to the preliminarily obtained voltage-current property of the standard OLED device. Referring to FIG. 7, the determination with respect to the abnormal pixel is made when the plate voltage of the OLED device 11 becomes V1 or lower, and further becomes V2 or higher. The pixel determined as the abnormal one is removed from the group subjected to the comparison.

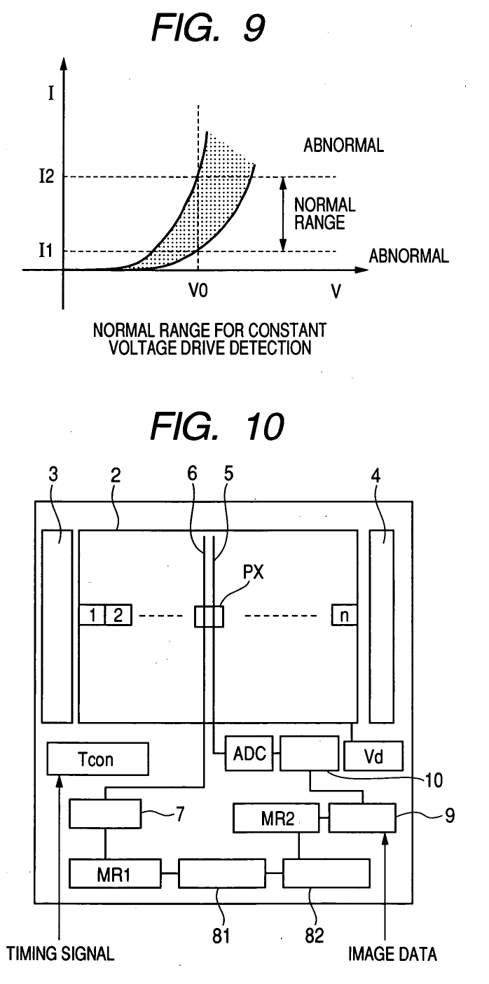

FIG. 8 shows the case where the constant voltage source is used for detecting the property of the OLED device 11, the operation of which has been already described. FIG. 9 shows an example of the detection results of the OLED device 11 using the circuit shown in FIG. 8. Referring to FIG. 9, the x-axis denotes the voltage applied to the anode of the OLED device 11, and y-axis denotes the current applied to the OLED device 11. As shown in FIG. 8, the constant voltage, for example, the voltage V0 shown in FIG. 9 is applied to the anode of the OLED device 11. When disconnection is about to occur in the OLED device 11, the current value becomes considerably small to become I1 or less. The phenomenon that the current value becomes considerably large to be I2 or more indicates that the short circuit in the OLED device 11 is about to occur.

It is possible to distinguish the normal pixel from the abnormal one in reference to the preliminarily obtained property of the standard OLED device 11. The determination with respect to the abnormal pixel is made when the current applied to the OLED device 11 becomes I1 or lower and further becomes I2 or higher so as to be removed from the group subjected to the comparison. FIG. 9 shows the current range corresponding to the constant voltage source, which may be converted to the voltage in the actual circuit. This makes it possible to allow the differential amplifier to detect the property as shown in FIG. 8.

FIG. 10 shows an exemplary organic electroluminescence display, specifically showing the operation in the embodiment. The basic operation, however, has been already described referring to FIG. 4, and the structure of each of the pixels PX is the same as the one shown in FIG. 5. Referring to FIG. 10, the specific line is selected to be subjected to the detection performed by the detection scanning circuit 4. During the detection, the data line 5 shown in FIG. 10 is disconnected from the pixel PX. Each line contains the arrangement of n pixels PX. The n pixels are subjected to switch scan with respect to the OLED device property sequentially from the left, for example. The detection circuit is used for detecting the voltage-current property of the OLED device 11 using the circuit which has been described referring to FIG. 6 or FIG. 8.

In the course of the detection with respect to the property of the OLED device 11 of the pixels PX from the left one, the detection result is AD converted so as to be stored in the first memory MR1 serving as the line memory for storing the data of the OLED device 11 on the single line. When the single line data are stored in the first memory MR1, they are sequentially read in the failure determination unit 81 for making a failure pixel determination. The failure determination unit 81 removes the pixel outside the specified range of the voltage-current property as the faulty pixel as described referring to FIG. 7 or 9, and transfers only the normal pixels to the burn-in determination unit 82.

The burn-in determination unit 82 compares the adjacent normal pixels with respect to the OLED device property such that it is determined whether or not the burn-in has occurred. The determination result will be stored in the second memory MR2 serving as the frame memory for storing the correction data for the entire screen. That is, in the second memory MR2, the burn-in data are updated by each line.

The calculation unit 9 calculates the corrected image data relative to the image data input from the host in reference to the burn-in data stored in the second memory MR2. The corrected image data are transferred to the latch 10. The digital data on the single line are converted into the voltage actually applied to the OLED device 11 by the analog-digital converter ADC.

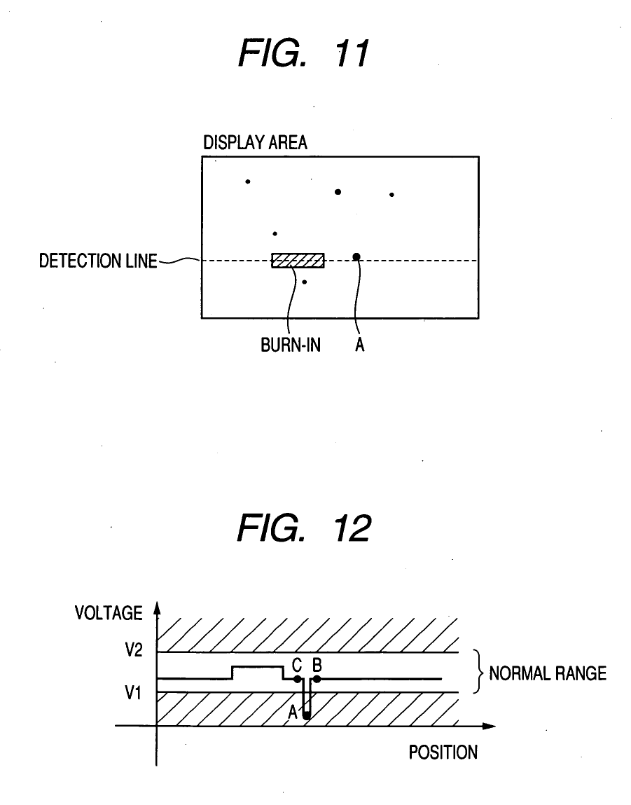

FIG. 11 shows an example of the screen where the burn-in is actually detected. Referring to FIG. 11, each black point denotes the faulty pixel. The shaded rectangular pattern denotes the burn-in area. It is assumed that the burn-in is caused by the display of the rectangular pattern for relatively a long period of time. The property of the OLED device 11 is detected along the inspection line indicated by the dashed line shown in FIG. 11, that is, the scanning line. The detection circuit employs the constant current source shown in FIG. 6.

FIG. 12 shows an anode potential of the OLED device 11 in the case where the pixels on the inspection line are sequentially subjected to the measurement from the left. The x-axis of the graph denotes a horizontal position of the pixel. The data are discretely shown as the respective pixels are subjected to the measurement. They are displayed by connecting the respective points corresponding to the pixels by lines. Referring to FIG. 12, if the pixel has the plate voltage higher than the value V2, and the anode potential lower than the value V1, it is determined as the faulty pixel. The information is then input to the failure determination unit 81.

The left one of the pixels on the screen is subjected to the detection as shown in FIG. 12. The left area where no burn-in occurs on the detection line represents that the OLED device 11 has the constant property. The area where the burn-in has occurred represents the deteriorated property of the OLED device 11. The resultant resistance of the OLED device 11 has increased to raise the plate voltage. The value obtained by AD converting the increase in the plate voltage is set as the burn-in amount which reflects the image data transmitted from the host in the calculation unit 9 shown in FIG. 10.

After passing the burn-in area, the plate voltage of the OLED device 11 returns to the normal value again. As the detection is further performed on the detection line, the faulty pixel A is detected on the detection line as shown in FIG. 11. The failure of this case occurs as the pixel is brought into the state where the short circuit is about to occur rather than the burn-in occurs. The change in the plate voltage of the OLED device 11 at the aforementioned time is shown in FIG. 12. Referring to FIG. 12, the code A denotes the anode potential of the faulty pixel. As the potential is lower than the value V, it is determined as being faulty by the failure determination unit 81 shown in FIG. 10 so as to be removed from the pixels to be compared.

Referring to FIG. 12, the pixels to the left and right of the faulty pixel A, that is, pixels C and B are normal pixels. The plate voltage of the pixel A is lower than that of the left pixel C. The resultant difference is expected to be feedbacked to the external image signal by the calculation unit 9 shown in FIG. 10. However, as the pixel A is determined as being faulty, the data are not reflected in the image signal to the pixel A. As the plate voltage of the right pixel B is lower than that of the faulty pixel A, the resultant difference is expected to be feedbacked to the external image signal. That is, the correction voltage is added to the external signal to apply the higher voltage to the pixel B. The luminance of the pixel B becomes too high to form the correct image.

In the embodiment, as the pixel A determined as being faulty is removed from the group to be compared, the pixel B is not subjected to the correction by error. The data of the pixel B are compared with those of the pixel C to the left of the faulty pixel A. As the plate voltage of the pixel C is the same as that of the pixel B, it is determined that no burn-in occurs in the pixel B. Accordingly, the calculation unit 9 shown in FIG. 10 performs no correction to the image signal from the host, thus displaying the correct image.

As described above, the burn-in determination unit 82 determines whether or not the burn-in has occurred through the comparison between the adjacent pixels. As the abnormal pixel is removed from the group to be compared, the correction by error may be avoided. The comparison is made among the normal pixels only such that the determination is made with respect to the burn-in or the degree thereof. The determination with respect to the correct degree of burn-in allows the accurate image display.

### Second Embodiment

In the first embodiment, the determination with respect to the burn-in of the pixel PX is made through the comparison between the pixel PX and the adjacent one. That is, the plate voltage of the OLED device 11 of the pixel to be measured is compared with that of the adjacent pixel. The aforementioned inspection, however, may cause the measurement error resulting from the comparison between the pixels to be accumulated.

In order to prevent the aforementioned error accumulation, the following process may be performed in the present embodiment. The organic electroluminescence display unit to which the present embodiment is applied has the same structure as the one shown in FIG. 10. The data of the respective pixels except those determined as being faulty by the failure determination unit 81 shown in FIG. 10 are transferred to the burn-in determination unit 82. In the present embodiment, the burn-in determination unit 82 generates the reference data serving as the reference of the comparison using the transferred data on the single line. Each amount of the burn-in of the respective pixels is determined through the comparison between the reference data and the respective data of the pixels. This may avoid the problem of the error accumulation resulting from the comparison between the adjacent pixels.

The reference data may be generated in the following process. The failure determination unit 81 transmits the data except those of the faulty pixels. That is, it may be determined that most of the transmitted data contain the information of the burn-in amount. The amount of the burn-in may be obtained through the statistical processing, that is, the difference between the value of the obtained data and the value derived from subtracting the standard deviation δ from the average value m, that is, m-δ. This makes it possible to perform the stable correction.

### Third Embodiment

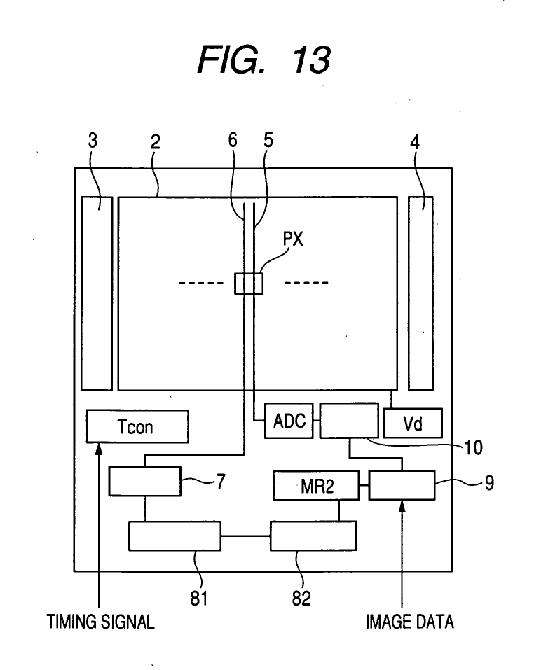

FIG. 13 shows an example of the organic electroluminescence display unit according to a third embodiment. In the embodiment, the process for detecting the data of the pixels PX on the detection line as the scanning line sequentially from the left as shown in FIG. 11 is the same as that of the first embodiment. In the present embodiment, the burn-in determination with respect to the pixel PX is performed through the comparison between the pixel PX and the data of the reference pixel rather than the comparison between the adjacent pixels.

In the embodiment, if the reference pixel is turned to be abnormal, all the correction data cannot be used. In order to overcome the aforementioned disadvantage, the reference pixel is also subjected to the periodic check whether or not it is maintained normal. For example, the normal range and the abnormal range for the reference data are predetermined as shown in FIG. 7. Then the process for eliminating the reference pixel determined as having deviating from the normal range is required. For example, the program may be structured to replace the reference pixel having the failure occurred with another one of those set as the reference pixels.

Referring to FIG. 13, assuming that the detection unit 7 employs the detection circuit shown in FIG. 6, the circuit is used for detecting the plate voltage of the OLED device 11. Every time when the detection unit 7 detects the property of the OLED device 11 of the pixel PX, the failure determination whether or not the subject pixel is the faulty pixel is made. The range of the plate voltage based on which the determination with respect to the faulty pixel is made is preliminarily set as shown in FIG. 7. Unlike the first embodiment which makes the faulty determination of the pixel PX after accumulating the determination result of the property of the pixel PX in the line memory, the present embodiment makes the faulty determination every time after the property determination of the pixel PX.

Only the data of the pixel determined as being normal by the failure determination unit 81 may be transferred to the burn-in determination unit 82. The burn-in determination unit 82 determines with respect to the amount of the burn-in by comparing the transferred data of the pixel with those of the reference pixel. That is, the difference between the plate voltage of the reference pixel and that of the pixel to be measured is evaluated so as to be transferred to the second memory MR2 as the frame memory.

The second memory MR2 stores the property data of the OLED devices 11 on the entire screen. The data of the subject pixel are updated by the newly transmitted data. The data of the faulty pixel are not updated. When the image data are transmitted from the host to the calculation unit 9 shown in FIG. 13, the corresponding data of the pixel are read from the second memory MR2, and the correction amount with respect to the image data is calculated. Then the image data after correction are transmitted to the latch 10. The subsequent operation is the same as that of the first embodiment shown in FIG. 10.

The present embodiment provides the same effects as those derived from the first embodiment. This makes it possible to eliminate the first memory MR1, that is, the line memory from the organic electroluminescence display, thus reducing the manufacturing costs.

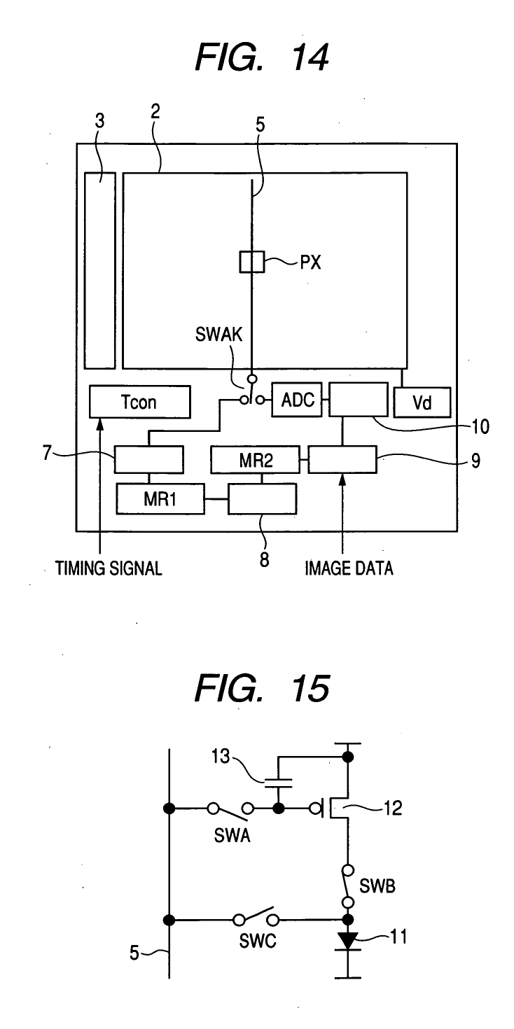

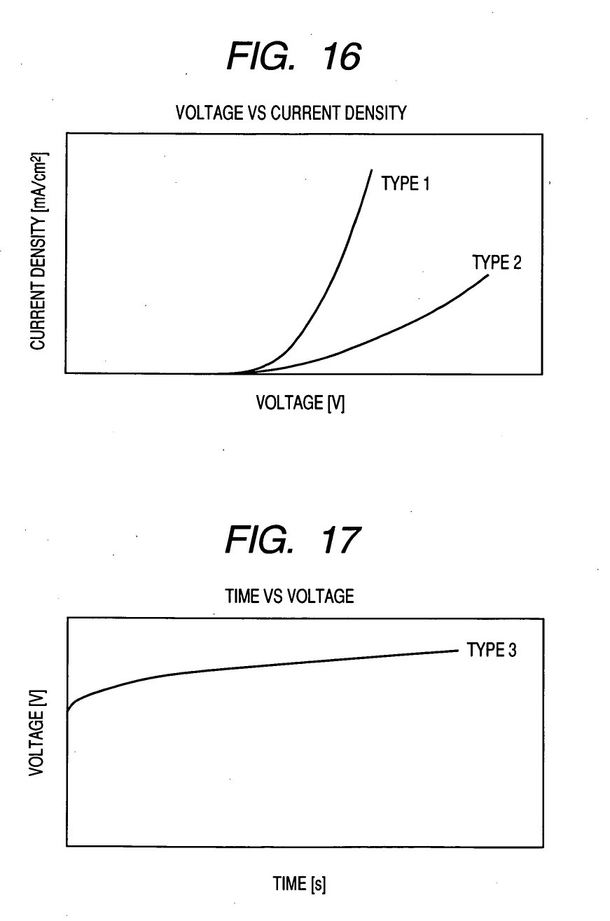

FIG. 14 shows an example of the organic electroluminescence display according to the fourth embodiment of the present invention. FIG. 15 shows the structure of the pixel PX shown in FIG. 14. In the first embodiment, the detection line 6 for detecting the property of the OLED device 11 and the data line 5 for supplying the image data are connected to the respective pixels. Meanwhile, in the present embodiment, the detection line is omitted, and the data line 5 serves as the detection line as shown in FIG. 13. The data line 5 is connected to the switch SWAK outside the display screen for switching between the image data supply circuit and the detection circuit.

FIG. 15 shows a circuit diagram of the pixel PX shown in FIG. 14. Referring to FIG. 15, both the A switch SWA and the C switch SWC are connected to the data line 5. When the image data are supplied to the pixel, the AK switch SWAK is connected to the image data supply circuit as shown in FIG. 14. Meanwhile, in case of the pixel shown in FIG. 15, the switch C is opened, and the switch A is closed, thus accumulating the charge corresponding to the image data in the storage capacitor 13. When the B switch SWB is closed, the current corresponding to the image signal is applied to the OLED device 11 to perform the tone display.

The AK switch SWAK shown in FIG. 14 is connected to the detection circuit for measuring the OLED device property of the pixel PX. Meanwhile, in case of the pixel shown in FIG. 15, the A switch SWA is opened, and the C switch SWC is closed. Then the current is applied from the constant current source of the detection circuit shown in FIG. 6 to the OLED device 11 such that the plate voltage of the OLED device 11 is measured.

As described above, the burn-in correction may be performed by allowing the data line 5 to detect the OLED device property instead of the detection line. The fourth embodiment makes it possible to simplify the structure of the organic electroluminescence display by eliminating the detection line.

The description with respect to the basic drive circuit as the pixel drive circuit for the organic electroluminescence display has been made for simplifying the explanation. It is to be clearly understood that the drive circuit for the pixel to which the present invention is applied is not limited to the one shown in FIG. 5 or 15. Generally, the drive circuit shown in FIG. 5 or 15 is used for emission of the OLED device 11 for a period corresponding to the single frame after writing the image data and closing the B switch SWB. Besides the case for emission of the OLED device 11 immediately after the image data writing, the present invention is applicable to the case for emission of the OLED devices 11 of all the pixels after writing the image data to all the pixels for the image data writing period which forms the period corresponding to the single frame together with the period for emission of the OLED device 11.

What is claimed is:

1. A display unit including a screen on which plural pixels each having an OLED device are arranged in a matrix, which measures a property of the OLED device at a predetermined time interval to reflect a change in the property of the OLED device in an image signal,
wherein the change in the property of the OLED device of a subject one of the plural pixels is obtained by comparing between the property of the OLED device of the subject pixel and the property of the OLED device of another pixel, which exist on a same scanning line.

2. The display unit according to claim 1, wherein the another pixel is adjacent to the subject pixel.

3. The display unit according to claim 1, wherein plural pixels are set as the another pixel to obtain the change in the property of the OLED device of the subject pixel by comparing a property derived from a statistical processing of the property of the OLED device of the plural pixels and the property of the OLED device of the subject pixel.

4. The display unit according to claim 1, further comprising a line memory for storing the property of the OLED device of the pixel on the scanning line.

5. A display unit including a screen on which plural pixels each having an OLED device are arranged in a matrix, which measures a property of the OLED device at a predetermined time interval to reflect a change in the property of the OLED device in an image signal,
wherein the change in the property of the OLED device of a subject pixel is obtained by comparing the property of the OLED device of the subject pixel and that of an another pixel in an image display area, and
wherein the property of the OLED device of the another pixel is in a predetermined range of the property of the OLED device.

6. The display unit according to claim 5, wherein the another pixel and the subject pixel exist on a same scanning line.

7. The display unit according to claim 5,
wherein the property of the OLED device of the subject pixel is represented by a voltage between terminals of the OLED device,
wherein the property of the OLED device of the another pixel is represented by a voltage between terminals of the OLED device, and
wherein the property of the OLED device of the another pixel is represented by the voltage between terminals of the OLED device for receiving a specific current application within a predetermined range.

8. The display unit according to claim 5, wherein the another pixel exists adjacent to the subject pixel, both of which exist on a same scanning line.

9. The display unit according to claim 5, wherein when the property of the OLED device of the another pixel is not in the predetermined range of the property of the OLED device, the property of the OLED device of the subject pixel is compared with that of a pixel adjacent to the another pixel.

10. The display unit according to claim 5, further comprising a line memory for storing the property of the OLED device of the pixel on the scanning line.

11. A display unit including a screen on which plural pixels each having an OLED device are arranged in a matrix, which measures a property of the OLED device at a predetermined time interval to reflect a change in the property of the OLED device in an image signal,
wherein the change in the property of the OLED device of a subject pixel is obtained by a comparison with the property of the OLED device of a predetermined reference pixel, and
wherein the property of the OLED device of the predetermined reference pixel is in a predetermined range; and
wherein the property of the OLED device of the reference pixel is subjected to a periodic inspection whether or not the property of the OLED device of the reference pixel is in the predetermined range.

12. The display unit according to claim 11,
wherein a plurality of the reference pixels exist; and
wherein when the property of the OLED device of the plurality of the reference pixels is not in the predetermined range of the property of the OLED device, another one of the reference pixels is subjected to the comparison with respect to the property of the OLED device.

13. The display unit according to claim 11,
wherein the property of the OLED device of the subject reference pixel is represented by a voltage between terminals of the OLED device,
wherein the property of the OLED device of the reference pixel is represented by a voltage between terminals of the OLED device, and
wherein the property of the OLED device of the reference pixel is represented by the voltage between terminals of the OLED device for receiving a specific current application within a predetermined range.

14. The display unit according to claim 11, wherein the change in the property of the OLED device of the subject pixel is detected by the comparison with the property of the OLED device of the reference pixel at each measurement of the property of the OLED device of the subject pixel.
